(19) United States
(12) Patent Application Publication
(10) Pub. No.: US 2024/0324634 A1
(43) Pub. Date: Oct. 3, 2024

(54) Extruded High Insoluble Fiber Food and High Total Fiber Pieces and Methods of Making

(71) Applicant: General Mills, Inc., Minneapolis, MN (US)

(72) Inventors: Jose Daniel Estrada Andino, Roseville, MN (US); Obediah Cooper, Coon Rapids, MN (US); Douglas L. Goedeken, Blaine, MN (US); Eric T. Gugger, Plymouth, MN (US); James Lombel, St. Michael, MN (US); Ravindranath Sreedhar Menon, Rogers, MN (US); Scott K. Whitman, New Hope, MN (US); Elizabeth Witt, Prior Lake, MN (US)

(21) Appl. No.: 18/625,812

(22) Filed: Apr. 3, 2024

Related U.S. Application Data
(60) Provisional application No. 63/456,625, filed on Apr. 3, 2023.
(60) Provisional application No. 63/625,499, filed on Jan. 26, 2024.

(51) Int. Cl. A23L 7/10; A23L 7/122; A23L 7/126; A23P 30/20

(52) U.S. Cl. CPC A23L 7/115; A23L 7/122; A23L 7/126; A23P 30/20

(57) ABSTRACT

The present disclosure relates to high fiber-containing ready-to-eat food pieces, compositions including such food pieces, and methods of making such food pieces. The food pieces include at least 35% and up to 55% by dry weight total fiber, an insoluble fiber content of at least 28% to about 40% by dry weight, and a soluble fiber content of about 7% to about 15% by dry weight. The food pieces include bran, optionally a second insoluble fiber source, psyllium husk, and a starch ingredient, with a moisture content of up to 4% by weight. Compositions containing such high fiber food pieces and methods of making them are also described.

### CROSS REFERENCE TO RELATED APPLICATIONS

This application claims the benefit of U.S. Provisional Patent Application Ser. No. 63/456,625, which was filed on Apr. 3, 2023 and titled “Extruded Puffed High Insoluble Fiber Food and High Total Fiber Pieces and Methods of Making” and U.S. Provisional Application Ser. No. 63/625,499, which was filed on Jan. 26, 2024 and titled “Extruded Puffed High Protein and High Fiber Food Pieces and Methods of Making”. The entire content of these applications is incorporated by reference.

### TECHNOLOGY

The present disclosure generally relates to an extruded high fiber product with high insoluble fiber content, and methods of making such a product.

### BACKGROUND

High dietary fiber-containing foods can help consumers balance their nutritional needs. In addition, fiber can help improve satiety while contributing fewer calories than protein, digestible carbohydrates, and fats. Consumers want diverse ways to get increased fiber into their diets. Thus, there is a need for new high fiber food products to satisfy the increasing consumer desire for convenient and enjoyable eating experiences that contribute fiber.

### SUMMARY

High total fiber and high insoluble fiber, ready-to-eat food pieces that contain a total fiber content of least 35% by weight and an insoluble fiber content of at least 28% by weight, and methods of making such food pieces are provided herein.

A ready-to-eat (RTE) food piece, including a bran, an optional second insoluble fiber source, psyllium husk, and a starch ingredient is provided. In some embodiments, bran, psyllium husk, and the starch ingredient are included in a RTE food piece in a combined amount of at least 80% by dry weight of the food piece, where the food piece includes: a bulk density of about 300 to about 750 g (about 300 to about 500 g) per 100 in3; a total fiber content of at least 35% to about 55% by dry weight of the food piece; an insoluble fiber content of at least 28% to about 40% by dry weight of the food piece with an amount of bran sufficient to provide insoluble fiber in an amount of at least 20% by dry weight of the food piece; a soluble fiber content of about 7% to about 15% by dry weight of the food piece, the psyllium husk contributing soluble fiber in an amount of about 7% to about 15% by dry weight of the food piece, wherein the insoluble fiber content and the soluble fiber content are included at a ratio of at least 2:1; a starch ingredient having a starch content of at least 50% by dry weight of the starch ingredient, wherein the starch ingredient, the psyllium husk, and the bran contribute a total starch content in an amount of about 35% to about 55% by dry weight of the food piece; and a moisture content of up to 4% by weight of the food piece. In some embodiments, the bran can be included in an amount sufficient to provide at least 90% by dry weight of the insoluble fiber content and the psyllium husk is included in an amount sufficient to provide at least 90% by dry weight of the soluble fiber content.

In some embodiments, bran, the second insoluble fiber source, psyllium husk, and the starch ingredient in a combined amount of at least 80% by dry weight of the food piece, where the food piece includes: a bulk density of about 300 to about 750 g (about 300 to about 500 g) per 100 in3; a total fiber content of at least 35% to about 55% by dry weight of the food piece; an insoluble fiber content of at least 28% to about 40% by dry weight of the food piece; an amount of the bran sufficient to provide insoluble fiber in an amount of at least 8% by dry weight of the food piece; an amount of the second insoluble fiber source sufficient to provide insoluble fiber in an amount of at least 8% by dry weight of the food piece, the second insoluble fiber source comprising oat hull fiber, sugar cane fiber, rice fiber, bamboo fiber, refined cellulose, or a combination thereof, where the bran and the second insoluble fiber source provide a total insoluble fiber content of at least 20% by dry weight of the food piece; a soluble fiber content of about 7% to about 15% by dry weight of the food piece, the psyllium husk contributing soluble fiber in an amount of about 5% to about 15% by dry weight of the food piece, wherein the insoluble fiber content and the soluble fiber content are included at a ratio of at least 2:1; a starch ingredient having a starch content of at least 50% by dry weight of the starch ingredient, wherein the starch ingredient, the psyllium husk, the bran, and the second insoluble fiber source contribute a total starch content in an amount of about 35% to about 55% by dry weight of the food piece; and a moisture content of up to 4% by weight of the food piece. In some embodiments, the ratio of insoluble fiber from the bran and insoluble fiber from the second insoluble fiber source can be from about 2:1 to about 1:2.

A RTE food piece can have a total fiber content of from about 38% to about 55% by dry weight of the food piece. A RTE food piece can have an insoluble fiber content is from about 30% to about 40% by dry weight of the food piece. A RTE food piece can have an insoluble fiber content and a soluble fiber content that are at a ratio of at least 3:1.

In some embodiments, the bran in a RTE food piece can include corn bran or wheat bran. In some embodiments, corn bran and wheat bran can be included in a RTE food piece at a ratio of 1:1 to 1:3 corn bran to wheat bran.

In some embodiments, the starch ingredient in a RTE food piece can include a grain flour or meal that contributes at least 50% by dry weight of the total starch content.

In some embodiments, other ingredients in a RTE food piece can total less than 8% by dry weight of the food piece.

Any RTE food piece provided herein can include a coating on at least a portion of a surface of the food piece.

RTE food products including any RTE food piece or coated food piece are also provided. In some embodiments, a food product can include an agglomeration of RTE food pieces and/or coated food pieces provided herein and optional other food pieces bound together with a binder.

Methods a RTE food piece are also provided herein. Such methods include, under extrusion conditions, combining ingredients to form a dough having a moisture content of about 8% to about 20% by weight of the dough, the dough comprising a bran, an optional second insoluble fiber source, psyllium husk, and a starch ingredient; extruding the dough through a die opening to form dough pieces; and drying the dough pieces to a moisture content of 4% or less and a bulk density of about 300 to about 750 g per 100 in3 to form a RTE food piece according to any of the disclosed embodiments.

A RTE food, having a total fiber content of at least 25% by weight of the food, and including a fiber ingredient blend, is also described herein. Such a fiber ingredient blend includes: a blend fiber content that is at least 70% by dry weight of the fiber ingredient blend, the blend fiber content comprising at least 85% by dry weight of the total fiber content of the food; bran in an amount sufficient to contribute insoluble fiber in an amount of about 60% to about 85% by dry weight of the blend fiber content; psyllium husk in an amount sufficient to contribute soluble fiber in an amount of about 12% to about 40% by dry weight of the blend fiber content, wherein the bran and the psyllium husk contribute about 90% to 100% of the blend fiber content. In some embodiments, the bran in a fiber ingredient blend can include corn bran and wheat bran at a ratio of about 1:1 to about 1:3 corn bran to wheat bran. In some embodiments, the fiber ingredient blend can include an ingredient that contributes soluble fiber other than psyllium in an amount of about 5% to about 10% by dry weight of the blend fiber content.

These and various other features and advantages will be apparent from a reading of the following detailed description.

### DETAILED DESCRIPTION

Consumers continually expect an even greater variety of convenient foods that deliver fiber and an enjoyable eating experience and are suitable for different eating occasions. A particular challenge in making high fiber RTE foods is in including significant amounts of fiber and still achieving a desirable flavor and texture similar to foods having low or moderate fiber content. For example, although commercially available high fiber granola bar products exist with fiber contents ranging up 30% by weight, they often rely heavily on soluble fibers, generally containing less than 10% by weight insoluble fiber. Consuming higher amounts of soluble fiber can lead to complaints of gastrointestinal discomfort, especially if consumed in a single serving. High fiber RTE foods also often fail to provide an eating experience that delights consumers, often presenting with a dry texture, grittiness, and/or off-flavors.

In contrast, it was discovered, and disclosed herein, that RTE foods that contain a fiber ingredient blend that includes contains bran and psyllium can achieve a pleasant texture and having a pleasant or neutral flavor, even in the absence of flavorants or off-flavor maskers. Such a fiber ingredient blend has a total fiber content that is at least 70% (e.g., at least 75%) by dry weight of the ingredient blend. The fiber blend includes bran (e.g., corn bran, wheat bran, or the like, or any combination thereof) in an amount sufficient to contribute insoluble fiber in an amount of about 60% to about 85% by dry weight of the total fiber content of the blend.

As used herein the term “bran” refers to the combined aleurone and pericarp of a cereal grain (e.g., corn, wheat, rice, barley, rye, oat, and the like). Insoluble fiber content of a bran suitable for use herein can range from about 40% to about 85% by dry weight. In some embodiments, bran in a food piece can have an average insoluble fiber content of greater than 50% by dry weight of the bran. In some embodiments, bran in a food piece can include bran from a combination of sources. For example, in some embodiments, a bran with an insoluble fiber content of 50% or less by weight (e.g., wheat bran, oat bran, rice bran) and a bran with an insoluble fiber content of greater than 50% (e.g., corn bran, rye bran, barley bran), can be combined at a ratio suitable to achieve an average insoluble fiber content of greater than 50%. For example, corn bran and wheat bran can suitably be used at a ratio of about 1:1 to about 1:3 (e.g., about 1:2). Other components of a bran can include, for example, starch, soluble fiber, protein, and fat.

The fiber ingredient blend also includes psyllium husk in an amount sufficient to contribute soluble fiber in an amount about 12% to about 40% by dry weight of the total fiber content of the blend. Although previous attempts at making a high fiber composition, such as disclosed in EP0144644, included psyllium husk, those attempts included psyllium husk as the source of most of the fiber and was included in a very broad range (e.g., 10-80% by weight). In contrast to the presently disclosed compositions, the compositions in EP0144644 failed to include significant amounts of insoluble fiber.

Bran and psyllium husk typically contribute to about 90% to 100% of the total fiber content of the fiber ingredient blend. In some embodiments, additional ingredients (e.g., pectin) can contribute fiber in an amount of up to 10% of the total fiber content of the blend. Thus, the compositions described herein, and products containing such compositions, can deliver significant amounts of insoluble fiber while also limiting the amount of fermentable fiber included in the compositions. Fermentable fibers are generally fermented in the colon by gut bacteria into fermentation by-products, such as short-chain fatty acids and gases, which can contribute to gastrointestinal discomfort. While most soluble fibers (e.g., inulin, beta-glucan, guar gum) are fermentable fibers, most insoluble fibers and psyllium are not fermentable fibers. In some embodiments, the fiber content of the described compositions can contain essentially no (e.g., less than 2% by dry weight, less than 1% by dry weight, or 0% by dry weight) fermentable fiber. Thus, the described compositions can be consumed with reduced risk of gastrointestinal discomfort associated with fermentable fiber consumption.

The fiber ingredient blend can be used to produce a high fiber RTE food piece that can achieve at least 35% (e.g., at least 35% to about 55%, or about 38% to about 55%) by dry weight total fiber, and including at least 28% (e.g., at least 28% to about 40%, or about 30% to about 40%) by dry weight insoluble fiber, while still having a pleasant, crunchy texture, and having a pleasant or neutral flavor, even in the absence of flavorants or off-flavor maskers. Such a food piece is suitable for eating alone (e.g., as a RTE breakfast cereal or snack), or included in other RTE formats, such as particulates in granola bars, yogurt or ice cream toppings or inclusions, particulates in trail mixes, inclusions or toppings for chocolates or confections, and the like.

A food piece provided herein has a bulk density of about 300 to about 750 (e.g., about 350 to about 600, or about 400 to about 500) g/100 cubic inches. A food piece having such a density can advantageously bring high levels of fiber to a RTE food product without excessive bulk. In addition, a food piece having the described density remains surprisingly crunchy without being too hard. Thus, a food piece provided herein remains suitable for eating alone as a RTE food product, yet also can be used in RTE products, such as snack bars without adding excessive bulk.

As used herein, the term “ready-to-eat” (“RTE”) refers to a food that does not require further cooking or preparation to be suitable and safe for consumption. A food piece provided herein is typically also shelf stable at room temperature for at least 6 months (e.g., at least 8 months, or 12 months to 18 months) without significant negative impact on texture, structure, or flavor when stored in appropriate packaging. A food piece provided herein typically has dimensions that are suitable for inclusion in a RTE food, such as a granola bar. A food piece provided herein can also be suitably coated, or it can be used in other products, such as dry snacks, as inclusions to be mixed in other products (e.g., yogurt or pudding), in snack blends, or in cold-formed or baked snack bars or clusters.

In some embodiments, a food piece provided herein includes a bran, psyllium husk, and a starch ingredient in a combined amount of at least 80% by dry weight of the food piece. In such embodiments, bran can be included in a food piece in an amount sufficient to provide insoluble fiber in an amount of at least 20% (e.g., at least 22%, or about 25% to about 40%) by dry weight of the food piece. In some embodiments, bran can be included in a food piece in an amount sufficient to provide at least 90% (e.g., at least 92%, or at least 95%) by dry weight of the insoluble fiber content of the food piece.

In some embodiments, a food piece provided herein includes a bran, a second insoluble fiber source, psyllium husk, and a starch ingredient in a combined amount of at least 80% by dry weight of the food piece. In such embodiments, bran and the second insoluble fiber source can be included in a food piece in an amount sufficient to provide insoluble fiber in an amount of at least 8% by dry weight of the food piece, each. Suitable second insoluble fiber sources include, for example, oat hull fiber, sugar cane fiber, rice fiber, bamboo fiber, refined cellulose, or combinations thereof. In some embodiments, at least 90% (e.g., at least 92%, or at least 95%) of the insoluble fiber content in a food piece comes from bran and a second insoluble fiber source selected from oat hull fiber, sugar cane fiber, rice fiber, bamboo fiber, refined cellulose, or combinations thereof. In some embodiments, where a second insoluble fiber source is included, the amount of insoluble fiber from the insoluble fiber and the amount of insoluble fiber from bran can be at a ratio of about 1:2 to about 2:1 (e.g., about 1:1).

As with the fiber ingredient blend described above, a food piece can contain bran from one or more sources, with a combination of corn bran and wheat bran being particularly suitable. In some embodiments, bran in a food piece can include corn bran and wheat bran at a ratio of about 1:1 to about 1:3 corn bran to wheat bran.

It should be understood that insoluble fiber content in a food piece provided herein is contributed mostly by bran and optional second insoluble fiber source, but can include some insoluble fiber found in other ingredients, such as a starch ingredient.

A food piece includes a soluble fiber content of about 7% to about 15% (e.g., about 7.5% to about 10%) by dry weight of the food piece, with at least a portion (e.g., at least 90%, at least 92%, or at least 95%) of the soluble fiber content being contributed by psyllium husk. In some embodiments, psyllium husk is included in an amount sufficient to contribute soluble fiber in an amount of about 7% to about 15% (e.g., about 7.5% to about 10%) by dry weight of the food piece. In some cases, psyllium can contribute to a desired texture of a food piece that is less hard and/or gritty than a food piece that contains no psyllium, while also contributing soluble fiber that is not fermentable.

A ratio of insoluble fiber content to soluble fiber content of at least 2:1 (e.g., at least 2.5:1, at least 3:1, about 3:1 to about 4:1, or about 3.2:1 to about 3.8:1) can maximize the amount of insoluble fiber content while achieving the desired density and texture. It should be understood that soluble fiber content in a food piece provided herein is contributed mostly by psyllium husk, but can include some soluble fiber found in other ingredients, such as a starch ingredient or bran. In some preferred embodiments, at least 90% (e.g., at least 92%, or at least 95%) of the soluble fiber content in a food piece comes from psyllium husk.

Although a psyllium content could reduce hardness and/or grittiness when combined with bran (and, optionally, a second insoluble fiber source), it was discovered that an amount of a starch ingredient was necessary to enable sustainable production since amounts of insoluble fiber exceeding 50% by dry weight resulted in an unacceptable appearance, flavor, and/or texture, while amounts of psyllium husk exceeding 15% resulted in puffing followed by collapse. A starch ingredient is included in a food piece provided herein. Generally, a starch ingredient contains at least 50% by weight starch. Suitable starch ingredients include, for example, a flour, a meal, a purified starch (e.g., native, modified, pregelatinized, or any combination), or a combination thereof. Preferably, a starch ingredient comprises a grain flour or meal, such as corn flour or corn meal.

The starch ingredient, the psyllium husk, the bran, and the optional second insoluble fiber source, contribute to a total starch content in a food piece of from about 35% to about 55% (e.g., about 40% to about 52%) by dry weight of the food piece. In some preferred embodiments, at least 50% (e.g., at least 55%, or at least 60%) of the total starch content in a food piece comes from a grain flour or meal.

It was discovered that the herein described combination and amounts of bran, optional second insoluble fiber source, psyllium, and starch ingredient balanced density and texture with a high insoluble fiber content without requiring significant amounts of other ingredients, such as sugars or proteins, to achieve an enjoyable eating experience. Thus, generally, less than 20% (e.g., less than 10%, less than 8%, less than 5%, or about 1% to about 4%) by dry weight of a food piece provided herein comprise ingredients other than bran, optional second insoluble fiber source, psyllium, and starch ingredient. Typically, other ingredients (e.g., sugars, flavorants, colorants, oil, processing aids, and the like) are individually included in amounts of less than 8% (e.g., less than 3%) each.

A food piece described herein can suitably be used in applications similar to a traditional particulates used in RTE snack foods, such as granola bars, soft baked snacks, trail mixes, and the like. For example, a food piece can have a coating, e.g., a carbohydrate-based, sugar alcohol-based, or fat-based coating, added to part or all of a surface to modify taste, appearance, texture, or the like. In some cases, a coating can contribute other attributes, such as crispness over shelf life in a snack bar. In some embodiments, a coating can be added at a rate of up to about 40% (e.g., about 10% to about 35%) by weight of the combined food piece and coating. It is to be understood that the description above with respect to ingredient content of a food piece does not take into account a coating.

A method provided herein includes processing a composition including a dry ingredients and water under extrusion conditions to produce a dough. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Berstorff, APV, Baker Perkins, Buhler, and Leistritz.

In some embodiments, food pieces provided herein can be extruded in a twin screw extruder with a barrel temperature of at least 180° F. (e.g., about 220° F. to about 350° F.). As used herein, the term “barrel temperature” refers to the maximum temperature of a heated barrel of an extruder. In some embodiments, extrusion conditions can comprise a specific mechanical energy (SME) of about 60 to about 120 Wh/kg. In some embodiments, extrusion conditions can comprise a die pressure of about 500 to about 2200 (e.g., about 700 to about 1500) psi.

A dough is typically made in a continuous fashion by feeding ingredients into an extruder during an extrusion process. In some embodiments, dry ingredients can be combined to produce a dry mix prior to being combined with water or other aqueous ingredients and, optionally, oil to produce a composition suitable for extrusion. In some embodiments, dry ingredients and a portion of water can be combined in a preconditioner prior to being fed into an extruder.

The dough generally contains the ingredients described above with regard to the food pieces. That is, the dough comprises a total fiber content of at least 35% to about 55% by dry weight, an insoluble fiber content of at least 28% to about 40% by dry weight, a soluble fiber content of about 7% to about 15%, and a total starch content of about 35% to about 55% by dry weight, and including bran, optional second insoluble fiber ingredient, psyllium husk, and starch ingredient, as described above. Moisture content of a dough is typically about 8% to about 20% by weight of the dough.

The dough can then be extruded from an extrusion die to form dough pieces. The dough pieces can be dried to a final moisture of less than 5% and density of 300 to 750 g per 100 cubic inches. Drying can be performed using any suitable method and equipment, such as a belt dryer.

In some embodiments, food pieces provided herein can have average diameter of from about 0.5 mm to about 20 mm (e.g., from about 1 mm to about 10 mm, or about 1 mm to about 5 mm). However, the size of a food piece can be adjusted for the desired use of the food piece or to provide a manufacturing advantage. For example, the size of a food piece can be adjusted to provide a desired size for eating as a stand-alone RTE breakfast cereal or snack, or for use as a component in a snack bar or snack mix. In another example, the size of a food piece can be adjusted to result in a desired drying time during manufacturing. Piece size can be adjusted using known methods, such as die opening size and/or die opening shape selection, rate of extrusion, and/or cutter speed. For example, cutter speed can be reduced to form elongated puffed pieces, such as pieces resembling churros or snack straws or sticks.

In some embodiments, food pieces provided herein can be packaged and sold as a food product without any other components. Such packaged food pieces can be intended to be eaten as a food product alone or in combination with other food products. For example, food pieces can be packaged and sold as a stand-alone snack, or as part of a RTE breakfast cereal. In some embodiments, a food piece can be adhered with one or more edible components, such as another food piece, nut pieces, fresh or dried fruit pieces, seeds, coconut, grain, and the like, to form a cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein, high fiber stand-alone food product or provide added protein and fiber in combination with other components in food products while also providing an improved texture and flavor over other known high protein, high fiber pieces.

### Examples

Samples were produced by extrusion using a twin screw extruder using the formulations in Table 1. Briefly, dry ingredients were blended to make a dry mix and then combined with water to arrive at a dough moisture indicated in Table 1. The dough was extruded from a die opening and cut into pieces approximately 2 mm to 10 mm. The dough pieces were dried to a moisture of about 4% using tray dryer or a belt dryer. The bran was a blend of corn bran and wheat bran. The psyllium husk was about 70% by dry weight soluble fiber. Other ingredients included calcium carbonate, sodium bicarbonate, salt, and oil.

TABLE 1

| | | Psyllium | Corn | Other | |
|---|---|---|---|---|---|
| | Bran (% | husk (% | meal (% | ingredients | Dough |
| Sample | dry mix) | dry mix) | dry mix) | (% dry mix) | moisture |
| 1 | 54-56% | 10-12% | 8-12% | 4-6% | 14-18% |
| 2 | 68-70% | 12-14% | 8-12% | 4-6% | 14-18% |

Table 2 shows the bulk density measured for each sample, the total fiber, insoluble fiber, and soluble fiber content for each sample.

TABLE 2

| | Bulk density | | Insoluble | |
|---|---|---|---|---|
| | (grams per 100 | Total fiber | fiber fiber | Soluble fiber |
| Sample | inch³) | (% dry wt) | (% dry wt) | (% dry weight) |
| 1 | 450-480 | 40-44% | 30-35% | 9-11% |
| 2 | 410-450 | 48-52% | 36-40% | 11-12% |

The samples each had an acceptable texture and flavor without requiring any flavorants, sugar, or flavor maskers.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A ready-to-eat (RTE) food piece, comprising a bran, psyllium husk, and a starch ingredient in a combined amount of at least 80% by dry weight of the food piece, wherein the food piece includes:
a. a bulk density of about 300 to about 750 g per 100 in³;
b. a total fiber content of at least 35% to about 55% by dry weight of the food piece;
c. an insoluble fiber content of at least 28% to about 40% by dry weight of the food piece with an amount of bran sufficient to provide insoluble fiber in an amount of at least 20% by dry weight of the food piece;
d. a soluble fiber content of about 7% to about 15% by dry weight of the food piece, the psyllium husk contributing soluble fiber in an amount of about 7% to about 15% by dry weight of the food piece, wherein the insoluble fiber content and the soluble fiber content are included at a ratio of at least 2:1;
e. a starch ingredient having a starch content of at least 50% by dry weight of the starch ingredient, wherein the starch ingredient, the psyllium husk, and the bran contribute a total starch content in an amount of about 35% to about 55% by dry weight of the food piece; and
f. a moisture content of up to 4% by weight of the food piece.

2. The RTE food piece of claim 1, wherein the total fiber content is from about 38% to about 55% by dry weight of the food piece.

3. The RTE food piece of claim 1, wherein the insoluble fiber content is from about 30% to about 40% by dry weight of the food piece.

4. The RTE food piece of claim 1, wherein the insoluble fiber content and the soluble fiber content are at a ratio of at least 3:1.

5. The RTE food piece of claim 1, wherein the bran is included in an amount sufficient to provide at least 90% by dry weight of the insoluble fiber content and the psyllium husk is included in an amount sufficient to provide at least 90% by dry weight of the soluble fiber content.

6. The RTE food piece of claim 1, wherein the bran comprises corn bran or wheat bran.

7. The RTE food piece of claim 7, wherein the bran comprises corn bran and wheat bran at a ratio of about 1:1 to about 1:3 corn bran to wheat bran.

8. The RTE food piece of claim 1, wherein the starch ingredient comprises a grain flour or meal that contributes at least 50% by dry weight of the total starch content.

9. The RTE food piece of claim 1, wherein the density is from about 300 to about 500 g per 100 in³.

10. The RTE food piece of claim 1, wherein other ingredients total less than 8% by dry weight of the food piece.

11. An RTE food product, comprising the RTE food piece of claim 1 and a coating on at least a portion of a surface of the food piece.

12. An RTE food product, comprising an agglomeration that includes a binder and a plurality of the RTE food pieces of claim 1, the binder binding the plurality together to form the agglomeration.

13. A method of making a RTE food piece, comprising:
a. under extrusion conditions, combining ingredients to form a dough having a moisture content of about 8% to about 20% by weight of the dough, the dough comprising a bran, psyllium husk, and a starch ingredient in a combined amount of at least 80% by dry weight of the dough, wherein the dough includes:
i. a total fiber content of at least 35% to about 55% by dry weight of the dough;
ii. an insoluble fiber content of at least 28% to about 40% by dry weight of the dough with an amount of bran sufficient to provide insoluble fiber in an amount of at least 20% by dry weight of the dough;
iii. a soluble fiber content of about 7% to about 15% by dry weight of the dough, the psyllium husk contributing soluble fiber content in an amount of about 7% to about 15% by dry weight of the dough, wherein the insoluble fiber content and the soluble fiber content are included at a ratio of at least 2:1;
iv. a starch ingredient having a starch content of at least 50% by dry weight of the starch ingredient, wherein the starch ingredient, the psyllium husk, and the bran contribute a total starch content in an amount of about 35% to about 55% by dry weight of the dough;
b. extruding the dough through a die opening to form dough pieces; and
c. drying the dough pieces to a moisture content of 4% or less and a bulk density of about 300 to about 750 g per 100 in³ to form the RTE food piece.

14. A ready-to-eat (RTE) food piece, comprising a bran, a second insoluble fiber source, psyllium husk, and a starch ingredient in a combined amount of at least 80% by dry weight of the food piece, wherein the food piece includes:
a. a bulk density of about 300 to about 750 g per 100 in³;
b. a total fiber content of at least 35% to about 55% by dry weight of the food piece;
c. an insoluble fiber content of at least 28% to about 40% by dry weight of the food piece;
d. an amount of the bran sufficient to provide insoluble fiber in an amount of at least 8% by dry weight of the food piece;
e. an amount of the second insoluble fiber source sufficient to provide insoluble fiber in an amount of at least 8% by dry weight of the food piece, the second insoluble fiber source comprising oat hull fiber, sugar cane fiber, rice fiber, bamboo fiber, refined cellulose, or a combination thereof, where the bran and the second insoluble fiber source provide a total insoluble fiber content of at least 20% by dry weight of the food piece;
f. a soluble fiber content of about 7% to about 15% by dry weight of the food piece, the psyllium husk contributing soluble fiber in an amount of about 5% to about 15% by dry weight of the food piece, wherein the insoluble fiber content and the soluble fiber content are included at a ratio of at least 2:1;
g. a starch ingredient having a starch content of at least 50% by dry weight of the starch ingredient, wherein the starch ingredient, the psyllium husk, the bran, and the second insoluble fiber source contribute a total starch content in an amount of about 35% to about 55% by dry weight of the food piece; and
h. a moisture content of up to 4% by weight of the food piece.

15. The RTE food piece of claim 14, wherein the ratio of insoluble fiber from the bran and insoluble fiber from the second insoluble fiber source is from about 2:1 to about 1:2.

16. A method of making a RTE food piece, comprising:
a. under extrusion conditions, combining ingredients to form a dough having a moisture content of about 8% to about 20% by weight of the dough, the dough comprising a bran, psyllium husk, a second insoluble fiber source, and a starch ingredient in a combined amount of at least 80% by dry weight of the dough, wherein the dough includes:
i. a total fiber content of at least 35% to about 55% by dry weight of the dough;
ii. an insoluble fiber content of at least 28% to about 40% by dry weight of the dough;
iii. an amount of the bran sufficient to provide insoluble fiber in an amount of at least 20% by dry weight of the dough;
iv. an amount of the second insoluble fiber source sufficient to provide insoluble fiber in an amount of at least 8% by dry weight of the dough, the second insoluble fiber source comprising oat hull fiber, sugar cane fiber, rice fiber, bamboo fiber, refined cellulose, or a combination thereof, where the bran and the second insoluble fiber source provide a total insoluble fiber content of at least 20% by dry weight of the dough;
v. a soluble fiber content of about 7% to about 15% by dry weight of the dough, the psyllium husk contributing soluble fiber in an amount of about 7% to about 15% by dry weight of the dough, wherein the insoluble fiber content and the soluble fiber content are included at a ratio of at least 2:1;
b. a starch ingredient having a starch content of at least 50% by dry weight of the starch ingredient, wherein the starch ingredient, the psyllium husk, and the bran contribute a total starch content in an amount of about 35% to about 55% by dry weight of the dough;
c. extruding the dough through a die opening to form dough pieces; and
d. drying the dough pieces to a moisture content of 4% or less and a bulk density of about 300 to about 750 g per 100 in³ to form the RTE food piece.

17. An RTE food, comprising a total fiber content of at least 25% by weight of the food, and including a fiber ingredient blend, wherein the fiber ingredient blend includes:
a. a blend fiber content that is at least 70% by dry weight of the fiber ingredient blend, the blend fiber content comprising at least 85% by dry weight of the total fiber content of the food;
b. bran in an amount sufficient to contribute insoluble fiber in an amount of about 60% to about 85% by dry weight of the blend fiber content;
c. psyllium husk in an amount sufficient to contribute soluble fiber in an amount of about 12% to about 40% by dry weight of the blend fiber content,
d. wherein the bran and the psyllium husk contribute about 90% to 100% of the blend fiber content.

18. The RTE food of claim 17, wherein the bran comprises corn bran and wheat bran at a ratio of about 1:1 to about 1:3 corn bran to wheat bran.

19. The RTE food of claim 17, wherein the fiber ingredient blend comprises an ingredient that contributes soluble fiber other than psyllium in an amount of about 5% to about 10% by dry weight of the blend fiber content.
